(19) United States
(12) Patent Application Publication
(10) Pub. No.: US 2003/0076975 A1
(43) Pub. Date: Apr. 24, 2003

(54) Speaker port system for reducing boundary layer separation

(76) Inventors: Brendon Stead, Thousand Oaks, CA (US); Clayton Williamson, Moorpark, CA (US)

Correspondence Address: VINCENT J. GNOFFO, BRINKS, HOFER, GILSON & LIONE, NBC TOWER, SUITE 3600, 455 N. CITYFRONT, CHICAGO, IL, 60611, US

(21) Appl. No.: 10/178,400

(22) Filed: Jun. 24, 2002

Related U.S. Application Data
(60) Provisional application No. 60/300,640, filed on Jun. 25, 2001.

(51) Int. Cl. H04R 1/02; H04R 1/20

(52) U.S. Cl. 381/345; 381/349

(57) ABSTRACT

This invention provides a speaker port with a flare having an inner wall that minimizes or reduces boundary layer separation. Fluids, such as air and sound waves, flow through the port at a higher velocity when boundary layer separation is minimized or reduced. The inner wall of the port is contoured so that the pressure gradient or change in pressure along the longitudinal axis of the port from its inlet duct to outlet duct is substantially constant.

### RELATED APPLICATIONS

This application is based on U.S. Provisional Patent Application No. 60/300,640 entitled “Flare Design for Minimizing Boundary Layer Separation” and filed on Jun. 25, 2001. The benefit of the filing date of the Provisional Application is claimed for this application.

### BACKGROUND OF THE INVENTION

1. Technical Field

This invention relates generally to loud speakers used in audio systems. More particularly, this invention relates to a speaker port with a contour that reduces boundary layer separation.

2. Related Art

There are many types of speaker enclosures. Each enclosure type can affect how sound is produced by the speaker. Typically, a driver is mounted flushed within the speaker enclosure. The driver usually has a vibrating diaphragm for emitting sound waves in front of a cone. As the diaphragm moves back and forth, rear waves are created behind the cone as well. Different enclosures types have different ways of handling these “rear” waves.

Many speakers take advantage of these rear waves to supplement forward sound waves produced by the cone. FIGS. 1 and 2 show a bass reflex enclosure that takes advantage of the rear waves. The enclosure has a small port. The backward motion of the diaphragm excites the resonance created by the spring of air inside the speaker enclosure and the mass contained within the port. The length and area of the port are generally sized to tune this resonant frequency. The port and speaker resonance is very efficient so the cone motion is reduced to near zero thereby greatly enhancing the bandwidth and the maximum output of the system that would otherwise be limited by the excursion of the cone.

In many speaker enclosures, sound waves passing through the port generate noise due to boundary layer separation. A sudden expansion or discontinuity in the cross-sectional area of the port can cause boundary layer separation of the sound waves from the port. Boundary layer separation occurs when there is excessive expansion along the longitudinal axis of the port. The fluid expansion causes excessive momentum loss near the wall or contour of the port such that the flow breaks off or separates from the wall of the port.

To minimize boundary layer separation, many port designs use flares in the shape of a nozzle at opposing ends of the port to provide smooth transitions. Often, different flares are tried until the “best” one is found. In many flare designs, the performance of the port may be poor because boundary layer separation will occur at the point along the longitudinal axis of the port where the adverse pressure gradient is largest. The pressure gradient or change in pressure may become great enough that the momentum of the sound wave or fluid is greater than the pressure holding the sound wave to the wall or contour. In this case, the sound wave separates from the wall, thus generating noise and losses. The point where the maximum pressure gradient occurs along the port limits the flow velocity from the port before separation occurs. Once the sound wave or flow separates from the port contour or wall at the point of maximum pressure gradient, flow losses increase dramatically and result in poor performance of the port.

### SUMMARY

This invention provides a speaker port having a substantially constant pressure gradient that reduces or minimizes boundary layer separation. With a substantially constant pressure gradient, there essentially is no point in the speaker port where a higher pressure gradient occurs to limit the velocity of the sound waves.

The speaker port comprises a flare having a substantially constant pressure gradient. In a method to reduce boundary layer separation in a speaker port, the inner wall of a flare is configured to have a substantially constant pressure gradient.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following figures. The components in the figures are not necessarily to scale, emphasis instead being placed upon illustrating the principals of the invention. Moreover, in the figures, like reference numerals designate corresponding parts throughout the different views.

FIG. 1 is a prior art cross-sectional view of a speaker enclosure with a transducer diaphragm in a rear position relative to its freestanding position.

FIG. 2 is a prior art cross-sectional view of the speaker with the diaphragm in a forward position relative to its freestanding position.

FIG. 3 is a side view of a port.

FIG. 4 is a cross-sectional view along Section A-A of the port shown in FIG. 3.

FIG. 5 is an enlarged cross-sectional view along Section B of the port shown in FIG. 4.

FIG. 6 is a cross-sectional view of a flare for a port in a speaker enclosure.

FIG. 7 is a graph illustrating a configuration for a flare.

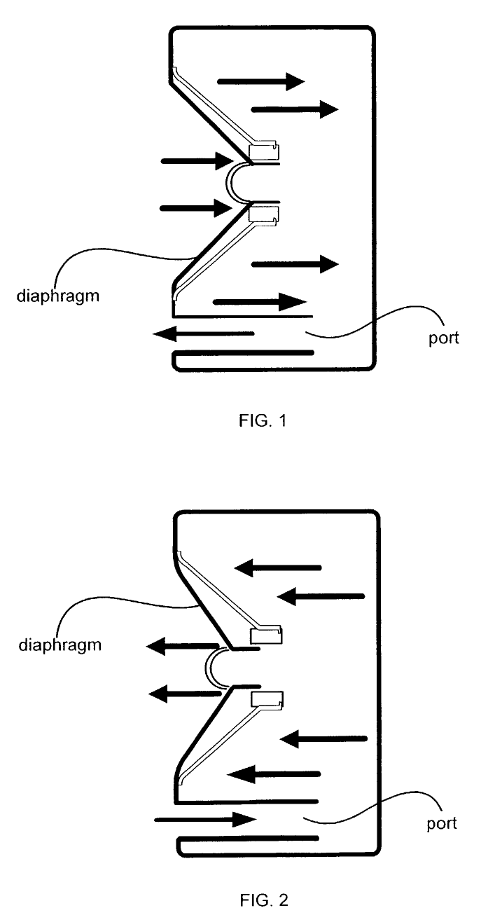

### DESCRIPTION OF THE PREFERRED EMBODIMENTS

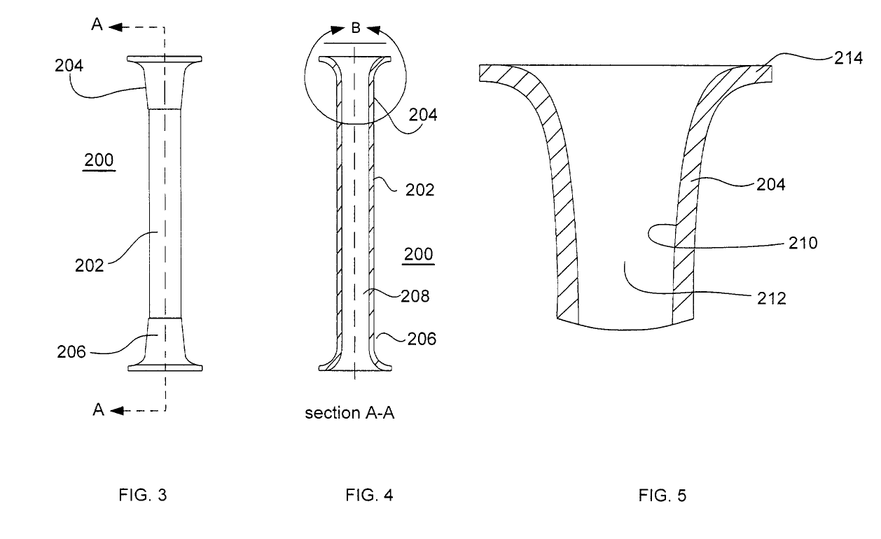

FIGS. 3-5 illustrate side and cross-sectional views of a loud speaker port 200. Port 200 has a cylinder 202 between two flares 204 and 206 that form a hollow core 208. Port 200 has an essentially circular cross-sectional area across the hollow core 208. Port 200 may have other cross-sectional areas across the hollow core 208 including an essentially elliptical cross-section. The port 200 may be non-circular and may be straight, bent, or have one or more curves. The port 200 may be symmetrical or non-symmetrical along a center axis. The port 200 may have other or a combination of configurations. The cylinder 202 and flare 204 and 206 may have the same or different configurations. The flares 204 and 206 are configured or shaped to provide a substantially constant pressure gradient for the sound wave or air flow through the port 200. The substantially constant pressure gradient reduces or minimizes boundary layer separation thus increasing or maximizing the air flow velocity through port 200. Each of the flares 204 and 206 has an inner wall or contour 210 between an inlet duct 212 and an outlet duct 214. The inner wall 210 is shaped or configured to provide substantially a constant pressure gradient over the entire length between the inlet and outlet ducts 212 and 214. While particular configurations are shown and discussed, port 200 may have other configurations including these with fewer or additional components.

The flares 204 and 206 each have an inner wall 210 that reduces or minimizes boundary layer separation so that fluids, such as air or sound waves, may flow through the flare at a higher velocity without boundary layer separation. The inner wall 210 is contoured so that the pressure gradient or change in pressure along the longitudinal axis of the flare from its inlet duct 212 to outlet duct 214 is substantially constant. The pressure gradient is substantially similar along the longitudinal axis of the flare. If the momentum or velocity of the fluid overcomes the pressure forces holding the flow to the wall, boundary layer separation can occur along the entire length of the flare. The performance of the flare improves because there is essentially no point along the longitudinal axis of the flare in which a higher pressure gradient occurs to limit velocity of the fluid. The point where a maximum or highest pressure gradient occurs has been changed so that performance is improved or optimized. With an essentially constant pressure gradient over the entire length of the flare, there is no peak or maximum pressure gradient at any point along the flare that limits the flow velocity of the fluid or sound wave.

In one aspect, the cylinder 202 is the interior portion of port 200 that has an essentially constant diameter. In this aspect, the flares 204 and 206 are the exterior portions of port 200 that have variable diameters. Generally, the cylinder 202 may be a separate or integral component of the flares 204 and 206. There may be no cylinder 202, when flare 204 transitions directly into flare 206. There may be only one flare or other multiples of flares. Flare 204 is essentially the same as flare 206. However, flare 204 may have different dimensions and/or a different configuration from flare 206.

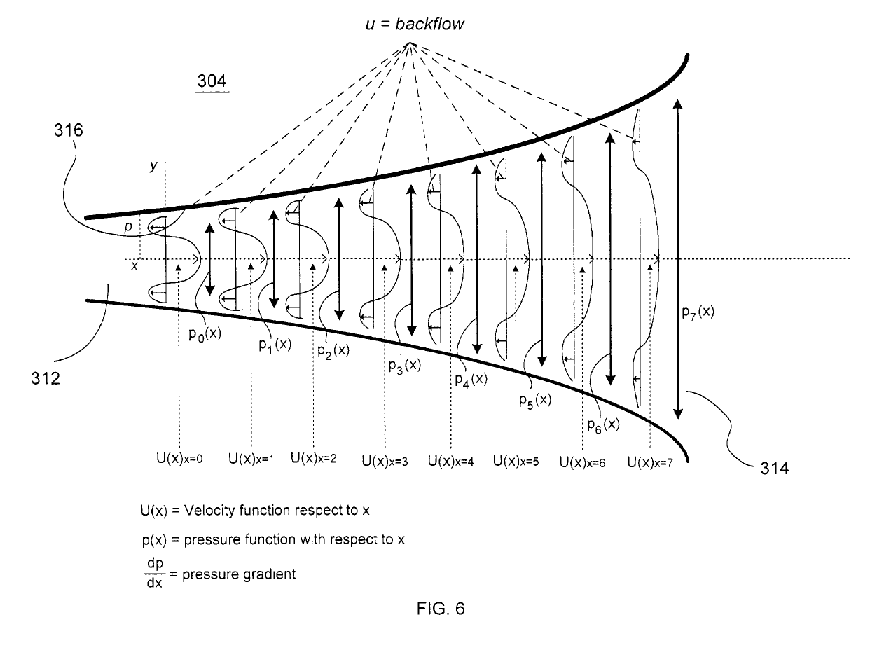

FIG. 6 represents a cross-sectional view of a flare 304 for a port in a speaker enclosure (not shown). The flare 304 provides substantially a constant pressure gradient over the entire length of the inner wall 310. The inner wall 310 is shaped or configured to achieve substantially a constant pressure gradient between inlet and outlet ducts 312 and 314. With a substantially constant pressure gradient, the flow velocity U(x) of fluid or sound waves passing through the flare at any given point along the x axis of the port is increased or maximized without boundary layer separation occurring. The pressure gradient is generally defined as dp/dx or simply, the change in pressure p over the change in distance x.

A substantially constant pressure gradient along the length of the flare 304 minimizes or reduces the adverse affect of the pressure gradient on any point and allows for a higher or maximum velocity of air flow to occur without boundary layer separation. A flare without a constant pressure gradient has one or more points from the inlet duct 312 to the outlet duct 314 with higher pressure gradients. Boundary layer separation can occur at high pressure gradient points along the flare with air velocities that are comparatively lower than if there was a constant pressure gradient.

The pressure at points along the length of the flare 304, P₀(x) through P₆(x), changes with respect the widening of the flare. If the change in pressure with respect to the change in distance is too high, an excessive adverse pressure gradient occurs. The pressure along the boundary of the walls 310 will not be enough to overcome the momentum of the sound wave or air flow U(x). An essentially constant pressure gradient allows a higher or maximum air flow velocity without flow separation because the constant pressure gradient causes the flow to expand uniformly along the points of the flare length as the sound wave or flow progresses through the flare 304.

The shape or contour of the inner wall 310 provides a substantially constant pressure gradient along the length of a circular flare and is defined or determined as follows:

$$\begin{matrix}\frac{ⅆ p}{ⅆ x} = constant & The pressure gradient ⅆ p / ⅆ x , & ( 1 ) \\ & is a constant . & \\ \frac{ⅆ p}{ⅆ x} = - ρ U ( x ) \frac{ⅆ ( U ( x ) )}{ⅆ x} & The Prantdl \text{/} Bernoulli & ( 2 ) \\ & Momentum \text{-} Integral relationship & \\ & relates the pressure gradient & \\ & to the velocity U ( x ) ( \frac{in}{sec} ) and & \\ & fluid density ρ ( \frac{lb}{{in}^{3}} ) . & \\ \frac{ⅆ p}{ⅆ x} + ρ U ( x ) \frac{ⅆ ( U ( x ) )}{ⅆ x} = 0 & Rearrange . & ( 3 ) \\ \frac{ⅆ ( p + ρ U ( x ) )}{ⅆ x} = 0 & Simplify . & ( 4 ) \\ p + \frac{ρ {U ( x )}^{2}}{2} = c & Integrate . & ( 5 ) \\ p = c - \frac{ρ {U ( x )}^{2}}{2} & Rearrange . & ( 6 ) \\ p = c - \frac{ρ {A}_{in}^{2} {U}_{in}^{2}}{2 {A ( x )}^{2}} & Substitute U ( x ) = \frac{{A}_{in} {U}_{in}}{A ( x )} , & ( 7 ) \\ & where {A}_{in} is the initial area & \\ & ( π {r}^{2} ) at the port opening or & \\ & inlet duct 312 and {U}_{in} is the & \\ & initial velocity at the flare & \\ & beginning or inlet duct 312. & \\ \frac{ⅆ p}{ⅆ x} = 0 - \frac{ρ {A}_{in}^{2} {U}_{in}^{2}}{2} \frac{ⅆ ( \frac{1}{{A ( x )}^{2}} )}{ⅆ x} & Differentiate . & ( 8 ) \\ \frac{ⅆ p}{ⅆ x} = 0 - \frac{ρ {A}_{in}^{2} {U}_{in}^{2}}{2 {π}^{2}} \frac{ⅆ ( \frac{1}{{y}^{4}} )}{ⅆ x} & Substitute A ( x ) = π {y}^{2} . & ( 9 ) \\ \frac{ⅆ ( \frac{1}{{y}^{4}} )}{ⅆ x} = \frac{2 {π}^{2} Δ}{- ρ {A}_{in}^{2} {U}_{in}^{2}} & Substitute \frac{ⅆ p}{ⅆ x} = Δ for & ( 10 ) \\ & convenience . & \\ \int [ \frac{ⅆ ( \frac{1}{{y}^{4}} )}{ⅆ x} ] = \int [ \frac{2 {π}^{2} Δ}{- ρ {A}_{in}^{2} {U}_{in}^{2}} ] & Integrate . & ( 11 ) \\ \to \frac{1}{{y}^{4}} = \frac{2 {π}^{2} Δ}{- ρ {A}_{in}^{2} {U}_{in}^{2}} x + c & Integration result . & \\ {y}^{4} = \frac{- ρ {A}_{in}^{2} {U}_{in}^{2}}{2 {π}^{2} Δ x} + c & Rearrange . & ( 13 ) \\ y ( x ) = \sqrt[4]{\frac{- ρ {A}_{in}^{2} {U}_{in}^{2}}{2 {π}^{2} Δ x} + c} & Final Equation . & ( 14 )\end{matrix}$$

The contour of a flare is calculated using Equation (14) with an initial velocity Uᵢₙ, an initial flare area Aᵢₙ that specifies the initial radius rᵢₙ such as Aᵢₙ=πrᵢₙ², a desired pressure gradient Δ=dp/dx, the fluid density ρ, and the integration constant c. Equation 14 may vary depending upon the initial cross-section area and other cross-sectional areas of the flare, especially when the flare is non-circular.

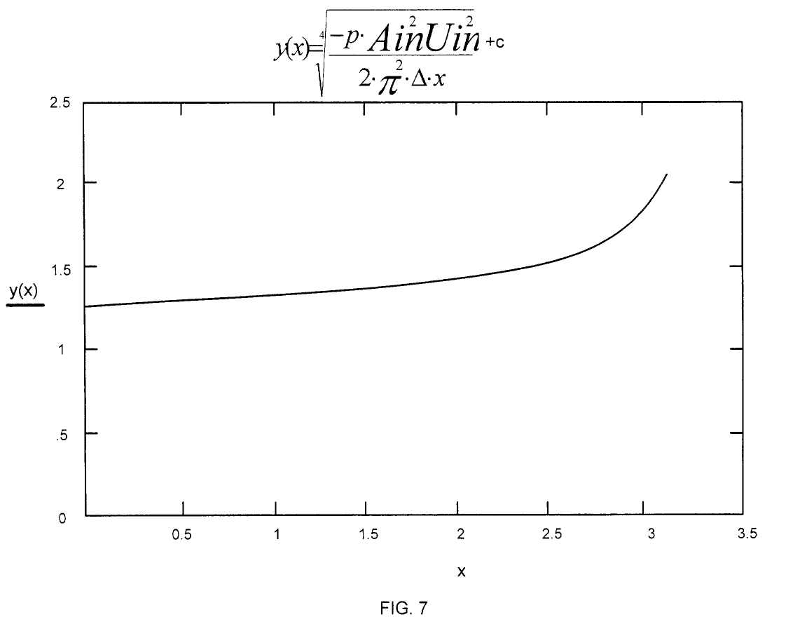

FIG. 7 is a graph illustrating the plot of a contour specifying the radius y in inches for a given position x in inches along the length of a flare. The pressure gradient remains constant at 240. The integration constant cᵢₙᵢₜᵢₐₗ is 1.375. The initial radius is 1.375 in. The fluid density is 0.0000466 lb/in³. These particular values and the related graph in FIG. 4 are for illustration purposes. Other values, graphs, and contours may be used. Any mathematical plot may be used to determine the contour of a port so long as the pressure gradient dp/dx remains substantially constant.

In another aspect, the shape or contour of the inner wall 310 provides a substantially constant pressure gradient along the length of a circular flare and is defined or determined as follows:

$$\begin{matrix}\frac{ⅆ p}{ⅆ x} = constant = Δ & The pressure gradient ⅆ p / ⅆ x is a & ( 15 ) \\ & constant Δ . & \\ \frac{ⅆ p}{ⅆ x} = - ρ U ( x ) ⅆ ( U ( x ) ) & The Prantdl \text{/} Bernoulli Momentum \text{-} & ( 16 ) \\ & Integral relationship relates & \\ & the pressure gradient is to the & \\ & velocity U ( x ) ( \frac{in}{sec} ) and fluid & \\ & density ρ ( \frac{lb}{{in}^{3}} ) . & \\ Δ \int ⅆ x = - ρ \int U ( x ) ⅆ ( U ( x ) ) & Integrate . & ( 17 ) \\ \to Δ x = - ρ \frac{{U}^{2} ( x )}{2} + c & Integration result . & \\ Δ x = - ρ \frac{{A}_{in}^{2} {U}_{in}^{2}}{2 {A}^{2} ( x )} + c & Substitute U ( x ) = \frac{{A}_{in} {U}_{in}}{A ( x )} , where & ( 18 ) \\ & {A}_{in} is the initial area ( π {r}^{2} ) at the & \\ & port opening or inlet duct 312 & \\ & and {U}_{in} is the initial velocity at the & \\ & flare beginning or inlet duct 312. & \\ p = Δ - \frac{ρ {A}_{in}^{2} {U}_{in}^{2}}{2 {π}^{2} {y}^{4}} + c & Substitute A ( x ) = π {y}^{2} and solve & ( 19 ) \\ & for y . & \\ y ( x ) \text{:} \sqrt[4]{\frac{- ρ {A}_{in}^{2} {U}_{in}^{2}}{2 {π}^{2} Δ x + c}} & Final Equation . & ( 20 ) \\ where c = - \frac{ρ {A}_{in}^{2} {U}_{in}^{2}}{2 π 2 {r}_{in}^{4}} & & \\ Y ( 0 ) = {r}_{in} . & & \end{matrix}$$

The contour of a flare is calculated using Equation (20) with an initial velocity Uᵢₙ, an initial flare area Aᵢₙ (which specifies the initial radius rᵢₙ such as Aᵢₙ=πrᵢₙ²), a desired pressure gradient Δ=dp/dx, and the fluid density ρ. Equation 20 may vary depending upon the initial cross-section area and other cross-section areas of the flare, especially when the flare is non-circular.

With either Equations (14) or (20), the inner wall 310 of the flare 304 may be shaped or configured to provide a substantially similar pressure gradient over the length of the flare 304 between the inlet and outlet ducts 312 and 314. With either Equation, the length of flare 304 between the inlet and outlet ducts 312 and 314 may be used to increase the velocity of the fluid or sound wave through the flare 304 while avoiding boundary layer separation. The inner wall of the flare 304 is thus shaped so that the pressure gradient along the flare 304 is substantially similar or constant, thus minimizing or reducing boundary layer separation.

The same port performance can be achieved using non-circular sections, non-symmetrical sections, or a combination. Equations 14 and 20 are adjusted by substituting the appropriate area relationship for the configuration of the port. In addition, the port may not be rotationally symmetrical. One side could be flat while the other side is varied to maintain the desired area expansion.

Other pressure and/or fluid equations may be used to shape or configure the inner wall to provide a substantially constant pressure gradient. Various computer programs may be used to perform the calculations of this invention including Matlab™ and Mathematica.™ These programs may be used to plot the contour of a flare while keeping the pressure gradient constant.

While various embodiments of the application have been described, it will be apparent to those of ordinary skill in the art that many more embodiments and implementations are possible within the scope of this invention. Accordingly, the invention is not to be restricted except in light of the attached claims and their equivalents.

What is claimed is:

1. A speaker port comprising a flare having a substantially constant pressure gradient.

2. The speaker port according to claim 1 where the flare is non-circular.

3. The speaker port according to claim 1 where the flare is not symmetrical about an axis.

4. The speaker port according to claim 1, where the flare further comprises an inner wall defined by the following equation,
$$y ( x ) = \sqrt[4]{\frac{- ρ {A}_{i n}^{2} {U}_{i n}^{2}}{2 {Π}^{2} Δ X} + c}$$
where y is a radius of the flare for a given position x on the inner wall, ρ is fluid density, Aᵢₙ is initial flow area, Uᵢₙ is initial velocity, Δ is pressure gradient dp/dx, and c is a constant.

5. The speaker port according to claim 1, where the flare further comprises an inner wall defined by the following equation,
$$y ( x ) = \sqrt[4]{\frac{- ρ {A}_{i n}^{2} {U}_{i n}^{2}}{2 {Π}^{2} Δ X + c}}$$
where y is a radius of the flare for a given portion x on the inner wall, ρ is fluid density, Aᵢₙ is initial flow area, Uᵢₙ is initial velocity, Δ is pressure gradient dp/dx, and c is a constant.

6. The speaker port according to claim 5, where
$$c = - \frac{{PA}_{i n}^{2} {U}_{i n}^{2}}{2 Π2 {r}_{i n}^{4}}$$
where rᵢₙ is an initial radius.

7. The speaker port according to claim 1, further comprising a seconds flare.

8. The speaker port according to claim 7, where the flares have essentially the same dimensions.

9. The speaker port according to claim 7, where the flares have essentially the same pressure gradient.

10. The speaker port according to claim 7, further comprising a cylinder connected between the flares, where the cylinder and flares form a hollow core.

11. The speaker port according to claim 10, where the hollow core has an essentially circular cross-section.

12. The speaker port according to claim 10, where the hollow core has an essentially elliptical cross-section.

13. The speaker port according to claim 1, where the flare further comprises an inner wall extending from an inlet duct to an outlet duct, and where the inner wall provides a substantially constant pressure gradient from the inlet duct to the outlet duct.

14. The speaker port according to claim 1, where the speaker port comprises a speaker enclosure.

15. A speaker port comprising:
at least one flare having an inner wall defined by the following equation;
$$y ( x ) = \sqrt[4]{\frac{- ρ {A}_{i n}^{2} {U}_{i n}^{2}}{2 ΠΔ x} + c}$$
where y is a radius of the at least one flare for a given position x on the inner wall, ρ is fluid density, Aᵢₙ is initial flare area, Uᵢₙ is initial velocity, Δ is a substantially constant pressure gradient dp/dx, and C is a constant.

16. The speaker port according to claim 15, where the flare is non-circular.

17. The speaker port according to claim 15, where the flare is not symmetrical about an axis.

18. The speaker port according to claim 15, further comprising a cylinder connected to the at least one flare, where the cylinder and at least one flare form a hollow core.

19. The speaker port according to claim 18, where the hollow core has an essentially circular cross-section.

20. The speaker port according to claim 18, where the hollow core has an essentially elliptical cross-section.

21. The speaker port according to claim 15, where the speaker port comprises a speaker enclosure.

22. A speaker port comprising:
at least one flare having an inner wall defined by the following equation,
$$y ( x ) = \sqrt[4]{- \frac{ρ {A}_{i n}^{2} {U}_{i n}^{2}}{2 ΠΔ x + c}}$$
where y is a radius of the at least one flare for a given position x on the inner wall, ρ is fluid density, Aᵢₙ is initial flow area, Uᵢₙ is initial velocity, Δ is an essentially constant pressure gradient dp/dx, and c is a constant.

23. The speaker port according to claim 22, where
$$c = - ρ \frac{{A}_{i n}^{2} {U}_{i n}^{2}}{2 Π2 {r}_{i {n}^{4}}}$$
where rᵢₙ is an initial radius.

24. The speaker port according to claim 22, when the flare is non-circular.

25. The speaker port according to claim 22, where the flare is not symmetrical about an axis.

26. The speaker port according to claim 22, further comprising a cylinder connected to the at least one flare, where the cylinder and at least one flare form a hollow core.

27. The speaker port according to claim 26, where the hollow core has an essentially circular cross-section.

28. The speaker port according to claim 26, where the hollow core has an essentially elliptical cross-section.

29. The speaker port according to claim 22, where the speaker port comprises a speaker enclosure.

30. A method for reducing boundary layer separation in a speaker port, comprising configuring an inner wall of a flare to have a substantially constant pressure gradient.

31. The method according to claim 24, further comprising defining a contour of the inner wall by the following equation,
$$y ( x ) = \sqrt[4]{- \frac{ρ {A}_{i n}^{2} {U}_{i n}^{2}}{2 {Π}^{2} Δ x} + c}$$
where y is a radius of the flare for a given position x on the inner wall, ρ is fluid density, Aᵢₙ is initial flare area, Uᵢₙ is initial velocity, Δ is pressure gradient dp/dx, and c is a constant.

32. The method according to claim 31, further comprising defining a contour of the inner wall by the following equation,
$$y ( x ) = \sqrt[4]{- \frac{ρ {A}_{i n}^{2} {U}_{i n}^{2}}{2 {Π}^{2} Δ x + c}}$$
where y is a radius of the flare for a given position x on the inner wall, ρ is fluid density, Aᵢₙ is initial flare area, Uᵢₙ is initial velocity, Δ is pressure gradient dp/dx, and c is a constant.

33. The method according to claim 32, where
$$c = - \frac{ρ {A}_{i n}^{2} {U}_{i n}^{2}}{2 Π2 {r}_{i n}^{4}}$$
where rᵢₙ is an initial radius.
